(19) United States
(12) Patent Application Publication
(10) Pub. No.: US 2024/0005076 A1
(43) Pub. Date: Jan. 4, 2024

(54) A LEARNING-BASED SURROGATE MODEL OF CONDUCTED NOISE FROM INTEGRATED CIRCUITS (ICS) UNDER DIFFERENT OPERATING CONDITIONS

(71) Applicant: SIMYOG TECHNOLOGY PVT.LTD, Bangalore (IN)

(72) Inventors: Bibhu Prasad NAYAK, Bangalore (IN); Nikita AMBASANA, Jamnagar (IN); Leela Krishna MANEPALLI, Bommasandra (IN); Debasish NATH, Kalyani (IN); Harikiran MUNIGANTI, Bengaluru (IN); Anant DEVI, Bengaluru (IN); Suraj R RAO, Bengaluru (IN); Dipanjan GOPE, Bengaluru (IN)

(73) Assignee: SIMYOG TECHNOLOGY PVT.LTD, Bangalore (IN)

(21) Appl. No.: 18/035,113

(22) PCT Filed: Oct. 29, 2021
(86) PCT No.: PCT/IN2021/051039

§ 371 Date: May 3, 2023

(30) Foreign Application Priority Data
Nov. 6, 2020 (IN) 202041048613

(51) Int. Cl. G06F 30/367

(52) U.S. Cl. CPC G06F 30/367; G06F 2219/10

(57) ABSTRACT

The present invention is related to a learning-based surrogate model capable of predicting operating condition-dependent time and/or frequency domain waveforms at the IC pins. The model of the present invention consists of a set of discrete features that can be extracted from a time-domain waveform and can be used to reconstruct the continuous time-domain waveform accurately and consequently reconstruct the frequency-domain characteristics of the time-domain waveform. The model of the present invention has a machine-learning framework e.g. an Artificial Neural Network, which can be trained to predict all the features extracted as a function of parameters characterizing the operating conditions.

### FIELD OF THE INVENTION

The present invention is related to the field of Electromagnetic Interference (EMI) and Electromagnetic Compatibility (EMC) and more specifically in the area of noise source modelling for radiated emission and conducted emission simulation.

### BACKGROUND OF THE INVENTION

Electromagnetic Interference (EMI) and Electromagnetic Compatibility (EMC) contribute to a significant percentage of compliance failures in the verification stage. This leads to loss of revenue due to delay-to-market or cancelled projects.

Front-loading EMI/EMC compliance testing at the early stage of IC-design OR early stage of hardware design is an effective method to analyse and monitor EMI/EMC performance right from the beginning such that possible problems can be addressed early in a cost-effective manner. Such an EMC-aware design process is likely to save, on average, 3-6 months in time-to-market.

To achieve system-level front-loading, 3D geometry files of PCBs, connectors, housing is available in an industry-standard format. The passive components like decoupling capacitor, discrete resistor, or inductor models also are available from the supplier website or can be easily measured. The problem lies in the unavailability of suitable IC models. A black-box model of the IC that hides the inner IP but is sufficient for performing EMI/EMC simulation, called IC-model for EMI/EMC, is therefore required.

A type of IC-model is a SPICE (“Simulation Program with Integrated Circuit Emphasis”) netlist representation of the IC which may be used in a DEVICE LEVEL general-purpose analog electronic circuit simulator. However, the SPICE model reveals the internal device details of the IC, and most IC-suppliers are hesitant to share this model with their customer from an IP perspective. Encrypted SPICE files however are often shared by the IC-supplier which limits the user to a given SPICE simulator. Further, the SPICE model often does not capture some device-level physics that may affect the EMC response at high frequencies.

Another model format is IBIS, which is a behavioral model that describes the electrical characteristics of the digital inputs and outputs of a device through V/I and V/T data without disclosing any proprietary information. IBIS models do not correspond to the conventional idea of a model that system designers are used to, such as a schematic symbol or polynomial expression, among others. An IBIS model consists of tabular data made up of current and voltage values in the output and input pins, as well as the voltage and time relationship at the output pins under rising or falling switching conditions. This tabulated data represents the behavior of the device. IBIS models are intended to be used for signal integrity analysis on systems boards. These models allow system designers to simulate and therefore foresee fundamental signal integrity concerns in the transmission line that connects different devices. Potential problems that can be analyzed utilizing the simulations include the degree of energy reflected by the driver from the wave that reaches the receiver due to mismatched impedance in the line; crosstalk; ground and power bounce; overshoot; undershoot; and line termination analysis, among others. The primary challenge with the IBIS model is that it does not capture information relevant for EMC analysis. For example, some of the switching waveforms on the power-ground lines, critical for EMC analysis at the system-level EMC analysis are not captured in IBIS. Further, these waveforms are typically dependent on the operating conditions of the IC. For example, for a DC-DC converter IC, the switching waveforms are dependent on several parameters e.g. switching frequency (fs), load current (Iload), etc.

In U.S. Pat. No. 6,031,986, A simulator and its operation, for simulating electromagnetic behavior of an IC (integrated circuit) of thin-film passive circuit components, use a simple equivalent circuit model to minimize computer processing time while retaining good model accuracy in spite of the energy losses and different film thicknesses, conductivities and dielectric properties which occur in a passive integration IC. The procedure includes the steps of creating a geometric model of a surface of the conductor pattern of the IC, forming a matrix representation of Maxwell's equations with values associated with electric and magnetic field couplings between locations each of which is centred on a main geometrical element, the main geometrical elements being a subset of geometrical elements in the geometric model, and then correlating values of matrix coefficients of the equations with coefficients of an admittance matrix representative of an equivalent circuit model for the conductor pattern in terms of sub-circuits which are interconnected with each other via main nodes having a one-to-one correspondence with the main geometrical elements. The sub-circuits between these main nodes of the equivalent circuit model for the passive integration IC includes sets of parallel branches of which a first branch includes a capacitor which models an electric field contribution, a second branch includes an inductor in series with a capacitor which together model a magnetic field contribution, and at least one further branch includes at least one resistor modelling a contribution to the energy loss of the electric and magnetic fields, the energy loss occurring in both dielectric and conductive material of the IC.

The IEC-62433-2 IC Emission Model-Conducted Emissions (ICEM-CE) was introduced as a standard IC-model for EMC to capture the conducted noise emission of an IC to apply to both Radiated and Conducted Emission analysis at the system level. The ICEM-CE model described in IEC-62433-2 is comprised of: (a) Passive Distribution Network (PDN) and (b) Internal Activity (IA). However, in the IEC-62433-2 standard, the noise source does not change with operating conditions.

Therefore, there is a requirement of a learning-based surrogate model using machine learning which effectively and accurately predicts the time and frequency domain waveforms of the IC under different operating conditions.

### Objectives of the Present Invention

The primary objective of the present invention is to provide a technique or model or system or learning-based surrogate model using machine learning which effectively predicts the time and frequency domain waveforms of an integrated circuit (IC) under different operating conditions.

The other objective of the present invention is to provide a method to recreate a model using machine learning which can effectively predict the time and frequency domain waveforms of an integrated circuit (IC) under different operating conditions.

Yet another objective of the present invention is to provide a method for recreating a behavioral prediction of an IC to be used in system-level simulation thereby identifying the Electromagnetic Interference (EMI) and Electromagnetic Compatibility (EMC) performance of the system.

### SUMMARY OF THE INVENTION

The present invention is related to a learning-based surrogate model capable of predicting operating condition-dependent time and/or frequency domain waveforms of the integrated circuit IC. The model of the present invention has a set of discrete features that can be identified from a time-domain waveform that can be used to reconstruct the periodic continuous time-domain waveform accurately and can also be used to reconstruct the frequency-domain characteristic of the time-domain waveform. The model of the present invention has a machine-learning framework e.g. an Artificial Neural Network, which can be trained to predict different features of a time-domain pulse e.g. rise time, fall time, pulse width, duty cycle, etc. accurately as a function of parameters characterizing the operating conditions. The different predicted features can be used to reconstruct the periodic continuous waveform.

### BRIEF DESCRIPTION OF DRAWINGS

The present invention is aiming to predict the behavior of an Integrated circuit, where the user has the integrated circuit (IC) or the printed circuit board (PCB) having at least an IC to be predicted for its conducted emission.

It is an important embodiment in the invention that the present invention is related to a learning-based surrogate model capable of predicting operating condition-dependent time and/or frequency domain waveforms of the integrated circuit IC.

It is another important embodiment of the invention that the model executed contains a set of discrete features that can be identified from a time-domain waveform that can be used to reconstruct the continuous time-domain waveform accurately and can also be used to reconstruct the frequency-domain characteristic of the time-domain waveform.

It is another aspect in the invention to provide a model including a machine-learning framework e.g. an Artificial Neural Network, which can be trained to predict the different features e.g. rise-time, fall time, duty-cycle, pulse-width etc. of a time-domain pulse accurately by extracting the features of the waveform as a function of parameters characterizing the operating conditions.

FIG. 1 shows the schematic diagram for a Printed Circuit Board (PCB) with the IC under consideration

FIG. 2 shows the fabricated PCB with the IC under consideration (a) front-side and (b) back-side

FIG. 3 shows the time-domain waveforms at IC-pin “Vsw” under different operating conditions.

FIG. 4 shows the frequency domain representation of the time-domain waveforms at IC-pin “Vsw” under different operating conditions

FIG. 5 shows the anatomy of a single time-domain pulse showing a subset of features.

FIG. 6 shows the process flow diagram for the generation of operating condition dependent IC-model

FIG. 7 shows the Example architectures for a subset of Artificial Neural Networks (ANNs) used in the modeling process

FIG. 8 shows the predicted vs. actual values for 4 features for different test-cases

FIG. 9 shows the Actual vs. Model-predicted values for time-domain IC waveform

FIG. 10 shows the Actual vs. Model-predicted values of frequency-domain representation of IC waveform

FIG. 11 shows the Actual vs. Model-predicted values for time and frequency domain IC waveforms for 6 different operating conditions

FIG. 12 shows the Graphical user interface for the developed IC-model

FIG. 13 shows the implementation of the IC model in a specific hardware

FIG. 14 the measurement vs. Simulation correlation for Conducted Emissions (CE) from the PCB the simulated waveform is generated using the IC model.

FIG. 15 A illustrates the passive probe and active differential probe used for measuring the time-domain waveform at the pins of the IC

FIG. 15 B illustrates the response waveform of the IC displayed in the oscilloscope

### DETAILED DESCRIPTION OF THE PRESENT INVENTION

This invention highlights a learning-based surrogate modelling methodology to model the Time and/or Frequency Domain waveform of an Integrated Circuit (IC) in different operating conditions as the internal constituents of the IC are unknown due to Manufacturer-Intellectual property (IP) reason and those ICs affect the Electromagnetic Compatibility (EMC) performance at the system-level and more specifically in the area of noise source modelling for radiated emission and conducted emission as noise execution The methodology involves acquiring measurements or simulation data over several different PCB layout variations and operating conditions settings for the IC referred to here as parameters. The process can be studied under the following steps.

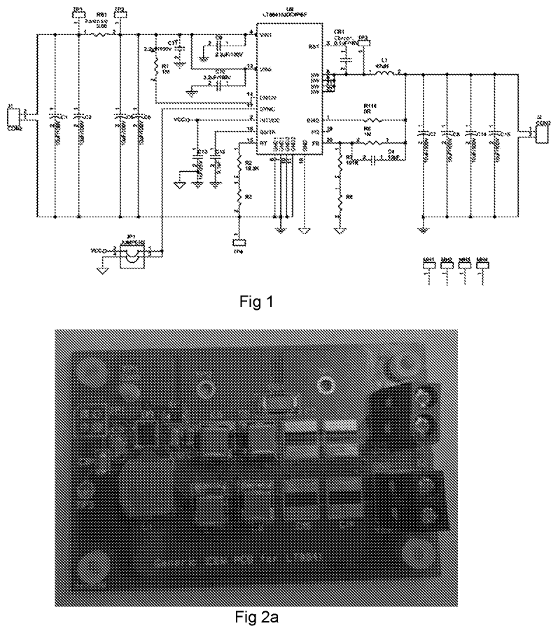

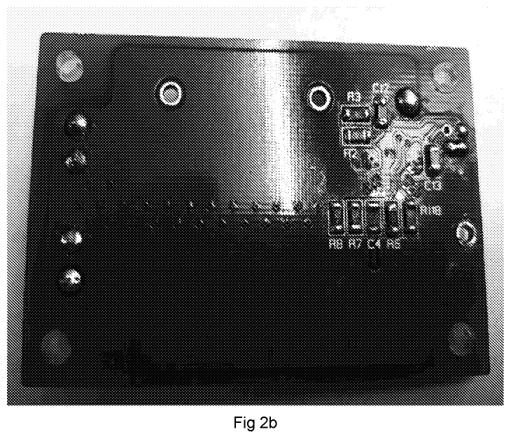

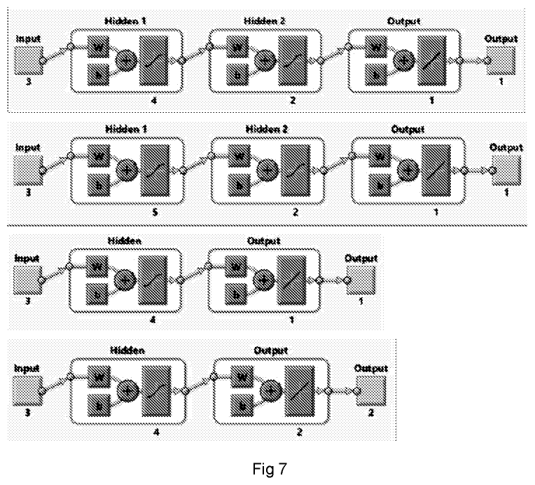

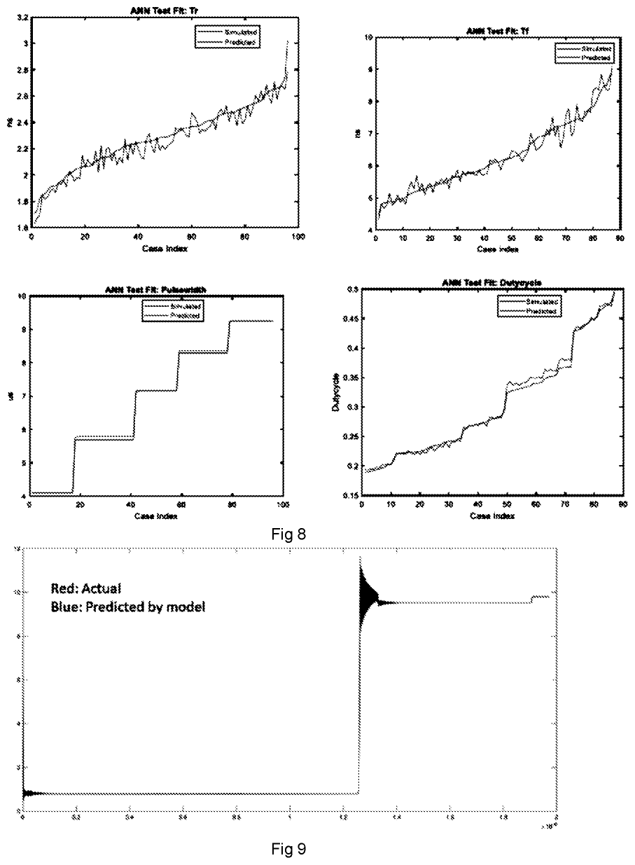

A model is proposed as one of the main embodiments in the invention where an IC-pin waveform is recreated from several trained Artificial Neural Networks. The operating conditions of the IC are represented as a set of parameter values and act as input to the set of Artificial Neural Networks. Each Artificial Neural Network is trained to predict a feature value. Several such features can be used to reconstruct the waveform of the IC, under given operating condition parameter values.
1. PCB preparation: A PCB is designed with the desired IC such that the operating conditions of the IC can be varied effectively. The schematic diagram of the PCB is shown in FIG. 1 and the fabricated PCB is shown in FIG. 2.
2. PCB measurement OR simulation: The operating conditions are carefully varied to change the IC waveforms. The waveforms are measured using an oscilloscope. In the case that a SPICE-compatible model of the IC is available, the PCB fabrication and measurement process can be replaced by a SPICE simulation of the schematic.
3. Identification of parameters: The parameters affecting the operating conditions are studied and a sensitivity analysis is performed to identify the critical parameters which have a significant effect on the waveform of the IC.
4. Design of Experiments (DoE): Once the parameters are identified, a method is formulated to generate a set of experiments with different parameter values to cover the parameter combination space required for the training in the next step. A possible choice is a Box-Behnken method.
5. Feature extraction: Once the DoE has been generated, the corresponding experiments are performed to generate the IC waveforms pertaining to each experiment. Each waveform then undergoes the feature extraction method which extracts the values of the specified features.
6. Network architecture and training: For each feature, an Artificial Neural Network is carefully architected and trained using a subset of the DoE (training set) to capture the effect of the parameters on that feature. Several such networks are generated, one each for a feature. Some example ANN architectures are shown in FIG. 7. FIG. 8 shows the performance of 4 such networks in predicting the desired feature value as a function of parameters for the remaining subset of the DoE (testing set).
7. Model generation: Finally the IC model is generated as a combination of:
(a) The trained neural networks each predict a feature.
(b) A reconstruction algorithm that combines the features to reconstruct the time-domain waveform
(c) An FFT utility that converts the time-domain to frequency-domain response
8. Model use:

A graphical user interface may be incorporated that accepts user-specified parameters to generate the model.

FIG. 1 shows the schematic diagram for a Printed Circuit Board (PCB) with the IC under consideration. A PCB is made capable of being mountable with a plurality of integrated circuits or ICs. Where that particular PCB board with IC can be taken for a behavioral test or EMI/EMC test.

FIG. 2 shows the fabricated PCB with the IC under consideration (a) front-side and (b) back-side

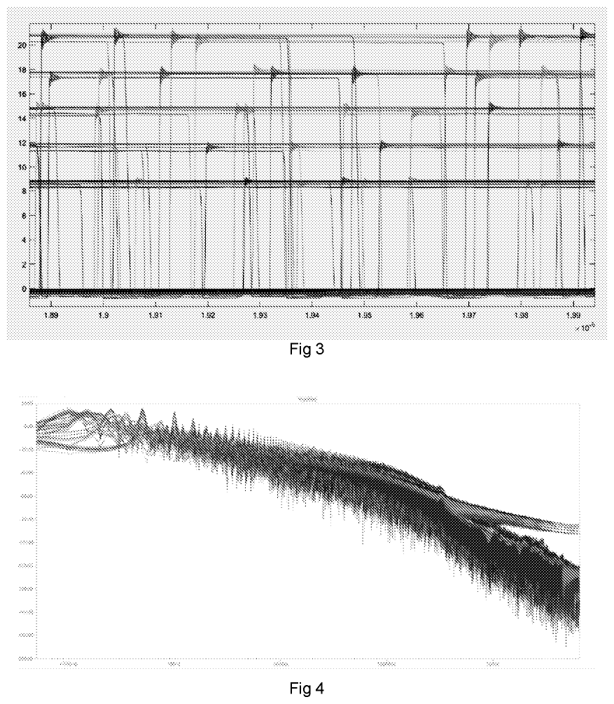

FIG. 3 shows the time-domain waveforms at IC-pin “Vsw” under different operating conditions. Where the operating condition as per the present invention is that the response of the IC is recorded based on the inputs not limited to electrical operating conditions or geometrical operating conditions. So the simulated waveform in FIG. 3 is plotted as time domain or frequency domain.

FIG. 4 shows the frequency domain representation of the time-domain waveforms at IC-pin “Vsw” under different operating conditions.

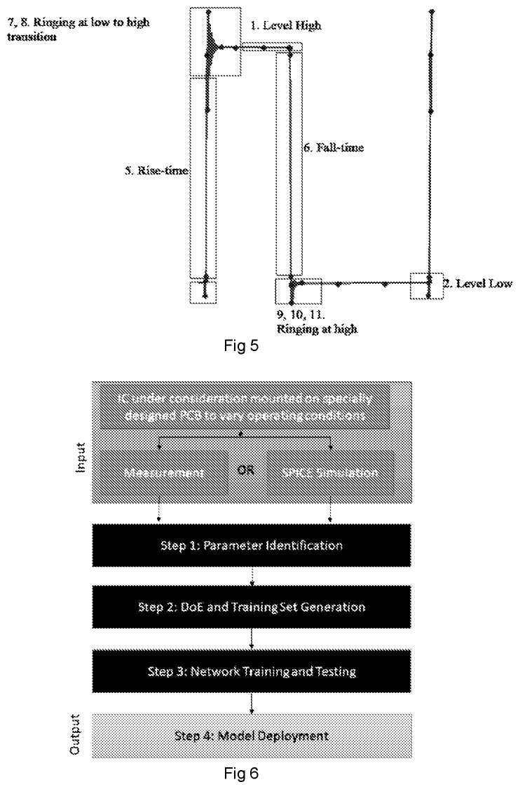

FIG. 5 shows the anatomy of a single time-domain pulse showing a subset of features. Where each feature is the extraction of the components of the waveform response, In FIG. 5 an example containing a waveform having features that include pre-transition overshoot and undershoot, rise time, fall time, and ringing between inter-transitional stages.

It is the main embodiment of the present invention to provide a method to generate a model by extracting the features of the time or frequency domain waveform of an IC-pin wherein features are pre-transition overshoot and undershoot, rise time, fall time, and ringing High level, low level, pulse-width, duty cycle, Bucket value between inter-transitional stages predicted with respect to different operating conditions.

FIG. 6 shows the process flow diagram for the generation of operating condition dependent IC-model, for that the following equipment or tools may be taken such as PCB with IC, a display device but not limited to an oscilloscope, CRO, or waveform generator wherein the process or method being characterized to the following steps,

Step 1: mounting the IC on the PCB, or PCB having pluralities of ICs to predict the behaviour, according to which operating condition dependent IC-model is to be generated,

Step 2: Recording the measurements on IC-pins characterized in such a way that at least a parameter is applied on the IC-pins to get response thereby the parameter that affects the behavior of the IC is recorded,

Step 3: generating a set of experiments with different parameter values to cover the parameter combination space required for the training in the next step. Wherein, higher-order response as the waveform is recorded by applying several sets of parameters. or any simulation data can be used as input parameters to cover the parameter combination space required for the training Artificial Neural Network.

Step 4: extracting features of the recorded waveform,

Step 5: Training artificial neural network

Step 6: instructing artificial neural network to perform step 1-step 4 under different operating conditions to re-generate or recreate the recorded waveform.

FIG. 7 shows the Example architectures for a subset of Artificial Neural Networks (ANNs) used in the modeling process, an Artificial Neural Network (ANN) is fit to reproduce the same behavior and generate the IC emission model. The predicted model is used to obtain the conduced emission (CE) and Radiated Emissions (RE) in an EMC simulation environment for different operating conditions of the device under test (DUT). The present invention approach is using a behavioural model using ANN as in most cases, the internal constituents of the IC are unknown due to Manufacturer-Intellectual property (IP) reasons.

Before generating an operating condition-dependent model, it is necessary to identify the parameters that are sensitive and responsible for the change in the emission levels of the DUT. The sensitivity analysis is carried out at the PCB level as well as the component level to observe the degree of change in the frequency spectrum of the IC-pins. A minimum-maximum analysis has been conducted to characterize these parametric elements based on their sensitivity. The parameters with the highest sensitivity are integrated into the model as data-generation parameters, further, used for training the Neural-Network model.

Different operating conditions are simulated while sweeping data generation parameter values as depicted in table 1 and 2. and the corresponding SW and Input pin Time Domain Signal for each operating condition is used to build the Neural Network dataset.

It is another important embodiment of the invention is that the following steps are required to be performed to train the Artificial Neural Network (ANN).

Step 1:

Collecting data in the form of time-domain or frequency-domain waveforms at IC-pins of interest using simulation of the IC or measurements carried using the specially designed test PCB of IC and by varying the parameter values.

Step 2:

Post-processing the waveforms to remove measurement artifacts such as random noise, alignment, or time shifts.

Step 3:

Extracting feature values from the time-domain waveforms obtained in Step 1. The tabulated amplitude vs. time values is processed and fitted with functional mathematical expressions to estimate the individual feature values through an optimization process.

If frequency-domain waveforms are available, then they are first converted to time-domain using a suitable FFT method.

The feature values thus obtained are stored along with the corresponding parameter values, as training input for neural networks.

Step 4:

Out of all the experiments performed in Step 1:
(a) 60% of the waveforms and their corresponding feature values and parameters are used to train a set of Artificial Neural Networks as per Step 5.
(b) 20% of the waveforms and their corresponding feature values and parameters are used for tuning the set of Artificial Neural Networks.
(c) Remaining 20% of the waveforms and their corresponding feature values and parameters are used for testing and performance evaluation of the set of Artificial Neural Networks.

Step 5:

Training a set of Artificial Neural Networks, one each for a given feature using the extracted feature values and parameter list from Step 3. A fully connected multi-layer feed-forward network configuration is chosen for training. The number of input neurons corresponds to the number of parameters representing the operating conditions while there is only a single output representing the feature for which the ANN is designed and trained. The number of hidden layers is typically 1 and the hidden layer is comprised of 3 or more neurons.

Step 6:

Once trained, each Artificial Neural Network, obtained from Step 5, is saved and can be used for inference in the reconstruction stage.

In the reconstruction stage, the predicted feature values for a given set of parameter values are used to reconstruct the time-domain waveform corresponding to the model for that operating condition. If required the said time-domain waveform can also be converted to frequency-domain waveform using a suitable FFT-based method.

FIG. 8 shows the predicted vs. actual values for features of different test-cases

FIG. 9 shows the Actual vs. Model-predicted values for time-domain IC waveform

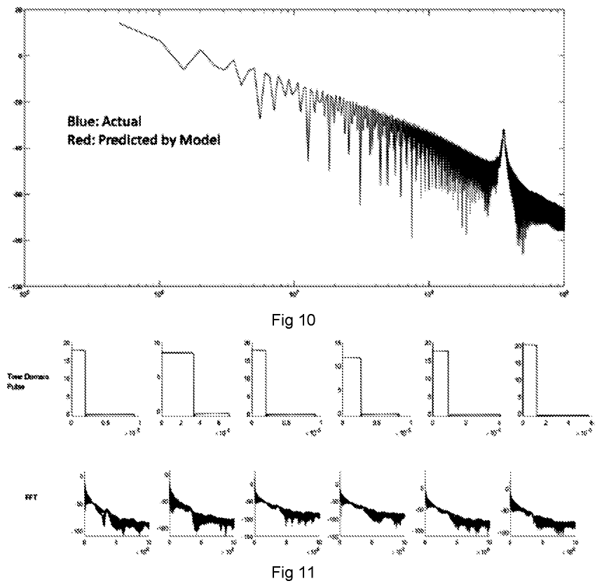

FIG. 10 shows the Actual vs. Model-predicted values of frequency-domain representation of IC waveform

FIG. 11 shows the Actual vs. Model-predicted values for time and frequency domain IC waveforms for different operating conditions

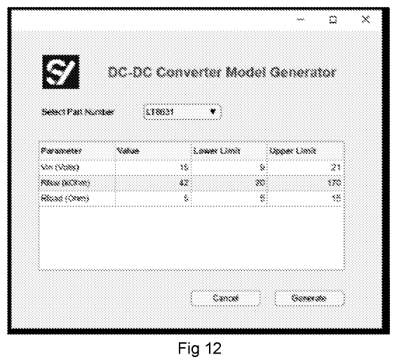

FIG. 12 shows the Graphical user interface for the developed IC-model

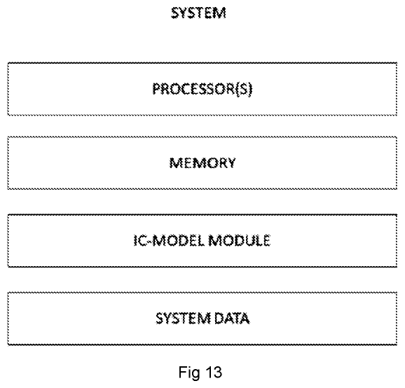

FIG. 13 shows the implementation of the IC model in a specific hardware

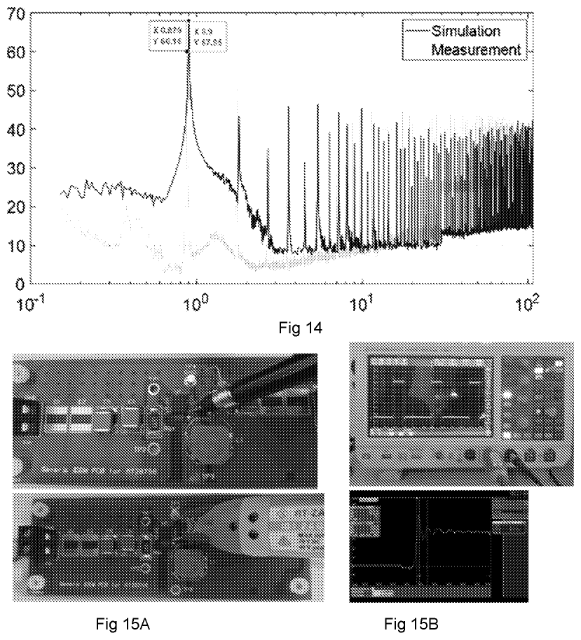

FIG. 14 the measurement vs. Simulation correlation for Conducted Emissions (CE) from the PCB the simulated waveform is generated using the IC model.

FIG. 15 A illustrates the passive probe and active differential probe used for testing the pins of the IC

FIG. 15B illustrates the response waveform of the IC displayed in the oscilloscope For example probes with different bandwidths, capabilities were used to evaluate the efficiency of the time-domain signals. A passive probe used for time-domain measurement and R&S ZD30 Active Differential Probe using (ZA-15) 10× attenuator as shown in FIG. 15A, B. The measurements are carried out on an R&S RTM3004 oscilloscope as shown in FIG. 15A, B.

### Example 1

The following example shows the Conducted Emissions (CE) & Radiated Emissions (RE) tests were performed for the following operating conditions for the PCB schematic for LT8641 The parameters that have been varied during the emission tests are Input Voltage (Vin), Load Resistor (Rload), Switching Frequency (Rfsw). The measured test cases are listed below-table

TABLE 1

| Case No | Input Voltage | Rload (I_{A}) | Switching Frequency (R_{fsw}) |
|---|---|---|---|
| 1. | 18 V | 10Ω (0.5 A) | 102K (500 KHz) |
| 2. | 18 V | 3.5Ω (1.5 A) | 102K (500 KHz) |
| 3. | 24 V | 10Ω (0.5 A) | 102K (500 KHz) |
| 4. | 30 V | 10Ω (0.5 A) | 102K (500 KHz) |
| 5. | 30 V | 5Ω (1 A) | 102K (500 KHz) |
| 6. | 30 V | 5Ω (1 A) | 47K (1 MHz) |

### Example 2

The following example is showing that the Time Domain Measurement for training Artificial Neural Network (ANN) to record

TABLE 2

| Parameter | Captured Values |
|---|---|
| I_{Load} | 0.5 A, 0.75 A, 1 A, 1.5 A, |
| Vₒᵤₜ | 5 V, 14 V, 24 V |
| Vᵢₙ | 8 V, 15 V, 22 V, 36 V |
| Switching Frequency | 0.3 MHz, 0.9 MHz, 1.2 MHz, 1.5 MHz |
| Effective Series Inductance (L_{eq}) | 3.77 nH, 6.27 nH, 8.77 nH, 13.77 nH |

An Artificial Neural Network (ANN) is an interconnected group of nodes, similar to our brain network. Here, we have three layers, and each circular node represents a neuron and a line represents a connection from the output of one neuron to the input of another. The first layer has input neurons which send input data via synapses to the second layer of neurons, and then via more synapses to the third layer of output neurons. Recent development in Compute hardware platforms like GPU has benefited training of ANN which was considered to be compute prohibitive even after decades of its invention. ANN form building blocks of Deep Learning which is now commonly used for predicting, optimizing large dataset non-linear problems with thousands of features.

Neural networks have a lot of different topologies or architectures. Wherein, the development of this neural network includes Feed forward-Network, one of the most basic and fully connected generic subsets of neural networks as shown in FIG. 7 is used.

A segment of time-series signals can create an impact on final correlation results. Impact on final results can be estimated by looking at Fast Fourier Transform (FFT) of signal with and without feature segment importantly that below features are necessary to predict FFT with sufficient accuracy.

TABLE 3

| Feature | Feature Name |
|---|---|
| 1 | High Level |
| 2 | Low Level |
| 3 | Duty Cycle |
| 4 | Pulse Width |
| 5 | Rise Time |
| 6 | Fall Time |
| 7 | Ringing Freq |
| 8 | Ringing Amp |
| 9 | Bucket Var1 |
| 10 | Bucket Var2 |
| 11 | Bucket Var3 |

From the above FIG. 1-FIG. 14, it is observed that a method to generate a surrogate behavioral model from noise emitted or exhibited at a pin of an integrated circuit under different operating conditions to train a set of artificial neural networks for recreation of a time or frequency domain behavioural model comprising of inserting an IC to be tested for behavioral model creation on the printed circuit board (PCB), measuring response behavior of the IC-pins by changing operating conditions as a function of a set of parameters where each parameter has a parameter range, in case of simulation, simulating response behavior of the IC-pins by changing operating conditions as a function of a set of parameters where each parameter has a parameter range, extracting a set of features from each of the measured/simulated time domain waveforms at IC-pins, training a set of artificial neural networks (ANN) to predict the behavior of the IC-pins using the set of features extracted, predicting the features corresponding to a new operating condition specified by a set of parameter values provided from a graphical user interface (GUI), with the set of trained artificial neural networks, recreating the time domain waveform by the predicted feature values corresponding to the new operating condition, recreating the frequency domain waveform from the time domain waveform corresponding to the new operating condition

Here the parameters affecting the behaviors of the IC are electrical or geometrical properties and the features of the time domain or frequency domain waveforms are pre-transition overshoot, undershoot, rise time, fall time, and ringing High level, low level, pulse-width, duty cycle, Bucket value and ringing between inter-transitional stages predicted with respect to operating conditions. If parameters are input to the Artificial Neural Network then features can be predicted to recreate the waveform of the IC-pins or features can be extracted from a time domain waveform and a time-domain waveform can be reconstructed from the features.

From reading the present disclosure, other variations and modifications will be apparent to persons skilled in the art. Such variations and modifications may involve equivalent features and/or other features which are already known in the use of circuit simulators and the computer-aided design and manufacture of conductor-pattern circuits and ICs, and which may be used instead of or in addition to features already described herein.

1. A method to generate a surrogate behavioral model from noise emitted or exhibited at a pin of an integrated circuit under different operating conditions to train a set of artificial neural networks for recreation of a time or frequency domain behavioural model comprising of:
inserting an IC to be tested for behavioral model creation on the printed circuit board (PCB),
measuring response behavior of the IC-pins by changing operating conditions as a function of a set of parameters where each parameter has a parameter range,
or
simulating response behavior of the IC-pins by changing operating conditions as a function of a set of parameters where each parameter has a parameter range,
extracting a set of features from each of the measured/simulated time domain waveforms at IC-pins,
training a set of artificial neural networks (ANN) to predict the behavior of the IC-pins using the set of features extracted,
predicting the features corresponding to a new operating condition specified by a set of parameter values provided from a graphical user interface (GUI), with the set of trained artificial neural networks
recreating the time domain waveform by the predicted feature values corresponding to the new operating condition,
recreating the frequency domain waveform from the time domain waveform corresponding to the new operating condition

2. The method to generate a surrogate behavioural model as claimed in claim 1, wherein the said parameters affecting the behaviors of the IC are electrical or geometrical properties.

3. The method to generate a surrogate behavioural model as claimed in claim 1, wherein the said features of the time domain or frequency domain waveforms are pre-transition overshoot and undershoot, rise time, fall time, and ringing High level, low level, pulse-width, duty cycle, Bucket value and ringing between inter-transitional stages predicted with respect to operating conditions.

4. The method to generate a surrogate behavioral model as claimed in claim 1, wherein, if parameters are input to the Artificial Neural Network then features can be predicted to recreate the waveform of the IC-pins.

5. The method to generate a surrogate behavioural model as claimed in claim 1, wherein, features can be extracted from a time domain waveform and a time-domain waveform can be reconstructed from the features.
